(19) United States
(12) Patent Application Publication
(10) Pub. No.: US 2005/0277759 A1
(43) Pub. Date: Dec. 15, 2005

(54) Process for adding furyl-2-methylidene UV light absorbers to poly(ethylene terephthalate)

(76) Inventors: Jason Clay Pearson, Kingsport, TN (US); Max Allen Weaver, Kingsport, TN (US); Perry Michael Murdaugh SR., Lexington, SC (US); Earl Edmondson Howell JR., Kingsport, TN (US)

Correspondence Address: Dennis V. Carmen;Eastman Chemical Company, P.O. Box 511, Kingsport, TN, 37662-5075, US

(21) Appl. No.: 10/855,747

(22) Filed: May 27, 2004

(51) Int. Cl. C08G 63/00

(52) U.S. Cl. 528/272

(57) ABSTRACT

A method for incorporating a UV light absorbing compound into a polyester prepared using direct esterification of reactants selected from a dicarboxylic acid and a diol, the method comprising reacting the reactants in an esterifying reactor under conditions sufficient to form an esterified product including at least one of an ester, an oligomer, or mixture having an ester and a mixture of low molecular weight polyester; polymerizing the esterified product in a polycondensation reactor to form a polyester; and adding the UV absorbing compound to the esterified products when at least 50% of the carboxy groups initially present in the reactants have been esterified to obtain a yield of UV absorbing compound incorporated into the polyester of greater than 40%. Articles utilizing the UV protected polyester are additionally disclosed.

### BACKGROUND OF THE INVENTION

1. Field of the Invention

The present invention relates to an ultraviolet (UV) light absorbing methylidene compounds, condensation polymers incorporating such UV absorbing compounds and a method for incorporating the UV light absorbing compounds into the condensation polymer.

2. Background of the Invention

Polyester is a widely used polymeric resin in a number of packaging and fiber based applications. Commercial polyester production, in general, involves direct esterification, where the desired glycol, in molar excess, is reacted with an aromatic dicarboxylic acid to form an ester; or by transesterification or ester exchange if the starting aromatic moiety is a low molecular weight diester of an aromatic dicarboxylic acid, such as dimethyl terephthalate (DMT) which is polycondensed under reduced pressure and at elevated temperatures form to poly(ethylene terephthalate) (PET). Since the product of these condensation reactions tend to be reversible and in order to increase the molecular weight of the polyesters, this reaction is often carried out in a multi-chamber polycondensation reaction system having several reaction chambers operating in series. In the case where the starting aromatic moiety is an aromatic dicarboxylic acid, water is the by-product of the reaction. In the case where the starting aromatic moiety is a diester of an aromatic dicarboxylic acid, such as DMT, methanol is the by-product of the reaction. In either case, the reaction by-product is removed by distillation.

The diglycol ester then passes to the second, prepolymerization step to form intermediate molecular weight oligomers before passing to the third, melt polyesterification step or polycondensation step operated at low pressure and high temperature. The molecular weight of the polymer chain continues to increase in this second chamber with volatile compounds being continually removed. This process is repeated successively for each reactor, with each successive reactor being operated at lower and lower pressures. The result of this step wise condensation is the formation of polyester with high molecular weight and a higher inherent viscosity relative to the esterification step. For some applications requiring yet higher melt viscosity, solid-state polymerization is practiced.

Poly(ethylene terephthalate) or a modified PET is the polymer of choice for making beverage and food containers such as plastic bottles and jars used for carbonated beverages, water, juices, foods, detergents, cosmetics, and other products. However, many of these products are deleteriously affected, i.e., degraded, by ultraviolet (UV) light at wavelengths in the range of approximately 250 to 390 nanometers (nm). It is well known that polymers can be rendered resistant to UV light degradation by physically blending in such polymers various UV light stabilizers such as benzophenones, benzotriazoles and resorcinol monobenzoates. Although these stabilizers function well to absorb radiation, many of these compounds would decompose under the conditions at which polyesters are manufactured or processed. Decomposition of such stabilizers frequently causes yellow discoloration of the polyester and results in the polyester containing little, if any, of the stabilizer.

U.S. Pat. No. 4,617,374 to Pruett et al. discloses the use of certain UV-absorbing methine compounds that may be incorporated into the polyester or a polycarbonate composition. These UV absorbing compounds have been found to be useful in the preparation of polyesters such as poly(ethylene terephthalate) and copolymers of poly(ethylene terephthalate) and poly(1,4-cyclohexylenedimethylene terephthalate). The compounds enhance ultraviolet or visible light absorption with a maximum absorbance within the range of from about 320 nm to about 380 nm. Functionally, these compounds contain an acid or ester group which condenses onto the polymer chain as a terminator. Pruett et al. teach preparing the polyester using transesterification and adding the UV absorbing compound at the beginning of the process. However, it has been discovered that the process by which the polyester is prepared contributes to the efficiency at which certain UV absorbing compounds are incorporated into the polyester. The loss of UV absorbing compounds results in added costs for the polyester formation.

Accordingly, there is a need for improved methods of incorporating UV absorbing compounds into polyester compositions made utilizing direct esterification of a diacid and a diol.

### SUMMARY OF THE INVENTION

One aspect of the present invention is a method for incorporating greater than 40% of the UV light absorbing compound into a polyester prepared using direct esterification process. The process includes the steps of directly esterifying reactants comprising a dicarboxylic acid and a diol at reaction conditions sufficient to form esterified products comprising at least one of: an ester, an oligomer, low molecular weight polyester and mixtures thereof; subjecting the esterified product to polycondensation to form a polyester; and adding at least one UV absorbing compound to at least one of the reactors when at least 50 percent of the carboxy groups initially present in the reactants have been esterified. In a preferred embodiment, from 0 to 100% of the desired amount of UV absorbing compound is added to the esterified product during one or more polycondensation steps wherein high molecular weight polyester may be prepared by subjecting the esterified products from the esterification reactor to a plurality of polycondensation zones of increasing vacuum and temperature.

Another aspect of the present invention is a polyester prepared utilizing the method of the present invention as well as articles made from the polyester composition.

Accordingly, it is an object of the present invention to provide a method for incorporating the UV absorbing compound into a polyester prepared using direct esterification of a diacid and a diol.

Another object of the present invention is a polyester having incorporated therein a UV absorbing compound, wherein the polyester is prepared using direct esterification of a diacid and a diol and wherein the yield of UV absorbing compound incorporated into the polyester is greater than 40%.

It is another object of the present invention is a polyester article wherein the polyester includes a UV absorber that is incorporated into the polyester by the method of the present invention.

These and other objects and advantages of the present invention will become more apparent to those skilled in the art in view of the following description. It is to be understood that the inventive concept is not to be considered limited to the constructions disclosed herein but instead by the scope of the appended claims.

### DETAILED DESCRIPTION OF THE INVENTION

The polyesters which may be used in accordance with the present invention include linear, thermoplastic, crystalline or amorphous polyesters produced by direct esterification and polymerization techniques from reactants selected from one or more dicarboxylic acids and one or more diols. As used herein, the term “polyester” is used broadly and includes homopolymers and copolymers. For example, a mixture of dicarboxylic acids, preferably aromatic dicarboxylic acids, and one or more diols may be heated in the presence of esterification and/or polyesterification catalysts at temperatures in the range of about 150° to about 300° C. and pressures of atmospheric to about 0.2 mm mercury. Normally, the dicarboxylic acid is esterified with the diol(s) at atmospheric pressure and at a temperature at the lower end of the specified range. The polyesters normally are molding or fiber grade and have an intrinsic viscosity (IV) of about 0.4 to about 1.2 dL/g, as measured in accordance with ASTM method D4603-03, using a solution of 0.25 grams of polymer dissolved in 25 ml of a solvent solution comprised of 60 weight % phenol and 40 weight % 1,1,2,2,-tetrachloroethane.

The preferred polyesters comprise at least about 50 mole percent terephthalic acid residues and at least about 50 mole percent ethylene glycol and/or 1,4-cyclohexanedimethanol residues, wherein the acid component has 100 mole % and the diol component has 100 mole %. Particularly preferred polyesters are those containing from about 75 to 100 mole percent terephthalic acid residues and from about 75 to 100 mole percent ethylene glycol residues, wherein the acid component has 100 mole % and the diol component has 100 mole %. As used herein, “residue” means the portion of a compound that is incorporated into a polyester composition after polycondensation.

Direct esterification processes are well known to those skilled in the art and include such processes described in U.S. Pat. Nos. 4,100,142; 3,781,213; and 3,689,481, the entire disclosures of which are incorporated herein by reference.

In one embodiment of the present invention, polyesters of suitable quality may be prepared in a continuous manner by directly esterifying the dicarboxylic acid with the glycol in an esterification reactor operated at a pressure above the partial vapor pressure of the glycol and at a reaction temperature sufficient to allow the continuous removal of water from the esterification reaction, continuing the esterification for a time sufficient to form esterification products and adding the UV absorbing compounds to the esterified products present when at least 50% of the carboxy groups initially present in the dicarboxylic acid reactant is esterified. Accordingly, the UV absorbing compound may added to the esterification reactor(s), the polycondensation reactor(s) or a combination of both esterification and polycondensation reactor(s). Such esterification products are well known to those skilled in the art and include at least one of: an ester, an oligomer, a low molecular weight polyester and mixtures thereof. An important aspect of the present invention is that at least 50% of the carboxy groups initially present in the reactants be esterified before the light absorbing compound(s) is/are added to the esterification products present in the esterification reactor. Desirably, at least about 70%, preferably at least about 80%, more preferably at least about 85% and most preferably greater than about 90% of the carboxy groups initially present in the reactants are esterified before the light absorbing compounds are added to the esterified products.

The amount of UV absorbing compound that may be added to the esterification reactor can range from 0 to 100% of the desired amount to be incorporated into the polyester. Preferably, the amount of UV absorbing compound added to the esterification reactor is from 0 to about 80% with the remaining amount added to the esterified products in the polycondensation reactor. More preferably, the amount of UV absorbing compound added to the esterification reactor is from 0 to about 50% of UV absorbing compound with the remaining amount added to the esterified products in the polycondensation reactor. It is understand that the amounts or quantitative ranges used herein includes not only those amounts expressly specified, but would also includes ranges therein. One skilled in the art will recognize that the amount of UV absorbing compound added to the reactor and the desired amount to be incorporated into the polyester may be different and depends upon the yield of the UV absorbing compound incorporated into the polyester.

It has been discovered that the amount of UV absorbing compound that may be added to the esterification reaction process and have a yield greater than 40% is directly proportional to the percentage of esterified carboxy groups initially present in the reactants. That is, as the amount of esterified products present in the esterification reaction process increases, an increasing amount of UV absorbing compounds can be added to the esterification reactor(s) without deleterious effects on the UV absorbing compounds. However, at least 50% of the carboxy groups initially present in the reactants should be esterified before any amount of UV absorbing compounds are added to the esterification reactor.

Following esterification, high molecular weight polyester may be prepared using any known polycondensation process wherein the esterification products prepared in the esterification reactor are passed through a plurality of zones of increasing vacuum and temperature terminating, for example, with a polymer finisher operating under a vacuum of about 0.1 to 10 mm Hg at a temperature of about 270° to 310° C. One skilled in the art will understand that such zones may be incorporated into a single reactor having a plurality of distinct operational zones, each of which have a distinct operating temperature, pressure and residence time or such zones may be represented by a plurality of distinct polycondensation reactors operated in series such that the polyester mixture is progressively polymerized in the melt phase where the polyester removed from the last reaction chamber has an inherent viscosity of from about 0.1 to about 0.75 dL/g, measured in accordance with the method described above.

In accordance with the present invention, from 0 to 100% of the desired amount of UV absorbing compound to be incorporated into the polyester may be added to the polycondensation reactor during any stage of polycondensation. Preferably, the amount of light absorbing compound that may be added to the polycondensation reactor during polycondensation is greater than 50%, more preferably greater than 80%, and most preferably greater than 95%. Although not to be bound to any theory, it is believed that the water evolved during esterification reduces the yield of light absorbing compound incorporated into the polyester. Thus, the light absorbing compound may be added to the esterification reactor(s) when at least 50 percent of the carboxy groups initially present in the reactants have been esterified, or desirably may be added to the polycondensation reactor(s) at any stage during polycondensation since the material in the polycondensation reactor generally has greater than 90 percent of the carboxy groups esterified. Alternatively, a portion of the UV absorbing compound can be added to the esterified products in the esterification reactor(s) and the balance of the UV absorbing compound is added to the PET in the polycondensation reactor(s).

Adding the UV absorbing compound in accordance with the present invention provides a yield of UV absorbing compound incorporated into the polyester of greater than 40%, preferably greater than 60%, more preferably greater than 70%, and most preferably greater than 85%. As used herein, “yield” is the percent value of the amount of UV absorbing compound residue(s) present in the polyester divided by the amount of UV absorbing compound(s) added to the process per unit of polymer.

The concentration of the UV absorbing compound, or its residue, in the condensation polymer can be varied substantially depending on the intended function of the UV-absorbing residue and/or the end use of the polymer composition. For example, when the polymer composition is for fabricating relatively thin-walled containers, the concentration of the UV absorbing compound will typically be in the range of from about 50 to 1500 ppm (measured in parts by weight UV absorber per million parts by weight polymer) with the range of about 200 to 800 ppm being preferred. Concentrations of UV absorbers may be increased to levels of from about 0.01 to about 5.0% if it is desired for the polymers containing these UV light absorbing compounds to have improved resistance to weathering and/or when the polymers or fibers made therefrom are dyed with disperse dyes. Polymer compositions containing substantially higher amounts of the UV absorbing compound, or its residues, e.g., from about 2.0 to 10.0 weight percent, may be used as polymer concentrates. Such concentrates may be blended with the same or different polymer according to conventional procedures to obtain polymer compositions which will contain a predetermined amount of the residue or residues in a non-extractable form.

The polyesters that are suitable for incorporating the UV absorbers in accordance with the method of the present invention are polyesters formed by the direct reaction of a dicarboxylic acid with a diol. The diacid component can be selected from aliphatic, alicyclic, or aromatic dicarboxylic acids. Suitable diacid components may be selected from terephthalic acid; naphthalene dicarboxylic acid; isophthalic acid; 1,4-cyclohexanedicarboxylic acid; 1,3-cyclohexanedicarboxylic acid; succinic acid; glutaric acid; adipic acid; sebacic acid; and 1,12-dodecanedioic acid. Preferably, the diacid component is terephthalic acid.

The diol component of the polyester may be selected from ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane wherein X represents 3, 4, or 5; diols containing one or more oxygen atoms in the chain, e.g., diethylene glycol, triethylene glycol, dipropylene glycol, tripropylene glycol, diols containing from about 2 to about 18, preferably 2 to 12 carbon atoms in each aliphatic moiety and mixtures thereof. Cycloaliphatic diols can be employed in their cis or trans configuration or as mixtures of both forms. More preferably, the diol includes ethylene glycol; diethylene glycol; 1,4-cyclohexanedimethanol; and mixtures thereof. In many cases, the diol may comprise a major amount of ethylene glycol and modifying amounts cyclohexanedimethanol and/or diethylene glycol.

The terephthalic acid and ethylene glycol may be fed separately into the esterification reactor. However, an economic benefit is realized by the employment of a single feed line supplying terephthalic acid and ethylene glycol to the esterification reactor. The duplication of feed system and pressure regulation problems with separate glycol and acid feed lines are eliminated with the employment of a single reactant feed system. It has been found that for substantially complete esterification of the dicarboxylic acid component in the reaction mixture, i.e., greater than 90%, an excess quantity of diol over the stoichiometric quantity is required. A diol/diacid ratio in the range of about 1.01:1 to 2.5:1, respectively, is desirable. Certainly, a greater excess of glycol would be operable, but would be uneconomical. With the employment of the self-compensating primary esterification unit, coupled with the fact that esterification and low molecular weight oligomer formation proceed nearly simultaneously, a relatively low molar ratio of diol/diacid of the order of 1.1:1 to 1.8:1, respectively is preferred. Optionally, a paste or slurry may be prepared from terephthalic acid/ethylene glycol in the molar ratio of about 1.2:1 to 1.4:1, respectively, and preferably about 1.3:1, respectively, to be pumped under an applied pressure to the esterification reactor.

The UV light absorbing compound can be added to the esterification reactor and/or polycondensation reactor using known methods for the addition of such additives. For example, the UV light absorbing compound may be added directly to the reactors via a separate feed line or may be mixed with any type of fluid that is compatible with a polyester process. The UV light absorbing compound can be a dilute solution or a concentrated dispersion or slurry that is capable of being pumped directly into the reactor or may be added to a carrier stream, such as one or more of the reactant or recycle streams. As one skilled in the art will understand, the singular term “reactor” can include a single reactor or a plurality of reactors, with each reactor having one or more reaction zones. Moreover, the term “reactor” can further include feed points that are physically located outside of the reactor, such as, for example, at a pump inlet or discharge, a recirculation line, a reflux point, as well as one or more points in associated piping and transfer equipment. For example, a side stream of products may be removed from the PET esterification process, the polycondensation process, or both, wherein the UV absorbing compound would be admixed with the contents of the side stream, which would then be returned to the reactor. However, the term “reactor” is used herein for the sake of brevity and clarity of description.

The UV absorbers used in the method of this embodiment are disclosed in U.S. Pat. No. 4,749,772, the entire disclosures of which are hereby incorporated by reference. The UV absorbers are characterized by having at least one furyl-2-methylidene radical of Formula I present: 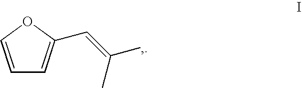
wherein the UV absorber includes a polyester reactive group.

Preferred compounds useful in the practice of the invention which contain the moiety of Formula I include one or more of the compounds represented by Formulae II and III below: 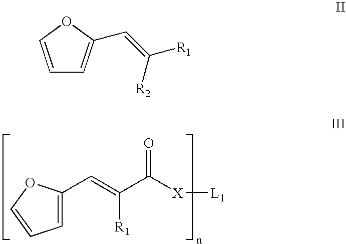
wherein:
X is selected from the group consisting of oxygen, —NH—, and —N(R′)—;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
n is a whole number ranging from 2 to 4;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; where the trivalent and tetravalent radicals are selected from the group consisting of C₃-C₈ aliphatic hydrocarbon having three or four covalent bonds. Examples of trivalent and tetravalent radicals include —CH(—CH₂—)₂ and C(CH₂—)₄.

More preferred furyl-2-methylidene compounds include the following Formulae IV-IV: 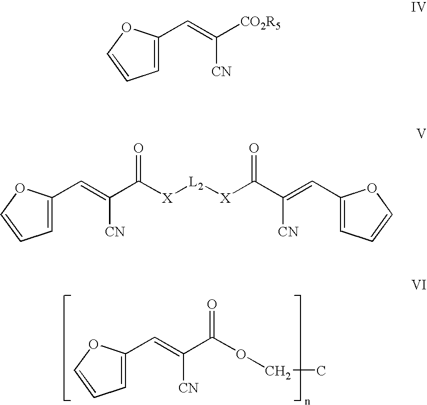
wherein:
X is as defined above;
R₅ is selected from the group consisting of C₁-C₆-alkyl, cyclohexyl, phenyl, and —(CHR′CHR″O—)ₚR₆;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—.

The alkoxylated moiety denoted herein by the formula —(CHR′CHR″O—)ₚ has a chain length wherein p is from 1 to 100; preferably p is less than about 50; more preferably p is less than 8, and most preferably p is from 1-3. In a preferred embodiment the alkoxylated moiety comprises ethylene oxide residues, propylene oxide residues, or residues of both.

The term “C₁-C₁₂-alkyl” is used to denote an aliphatic hydrocarbon radical that contains one to twelve carbon atoms and is either a straight or a branched chain.

The term “substituted C₁-C₁₂-alkyl” is used to denote a C₁-C₁₂-alkyl radical substituted with 1-3 groups selected from the group consisting of the following: halogen, hydroxy, cyano, carboxy, succinimido, glutarimido, phthalimidino, phthalimido, 2-pyrrolidono, C₃-C₈-cycloalkyl, aryl, acrylamido, o-benzoicsulfimido, —SO₂N(R₁₃)R₁₄, —CON(R₁₃)R₁₄, R₁₃CON(R₁₄)—, R₁₅SO₂—, R₁₅O—, R₁₅S—, R₁₅SO₂N(R₁₃)—, —OCON(R₁₃)R₁₄, —CO₂R₁₃, R₁₃CO—, R₁₃OCO₂—, R₁₃CO₂—, aryl, heteroaryl, heteroarylthio, and groups having formula VII: 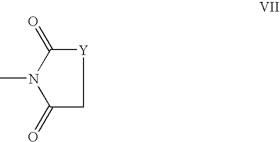
wherein:
Y is selected from the group consisting of C₂-C₄-alkylene; —O—, —S—, —CH₂O— and —N(R₁₃)—;
R₁₃ and R₁₄ are selected from the group consisting of hydrogen, C₁-C₆-alkyl, C₃-C₈-cycloalkyl, C₃-C₈-alkenyl, and aryl;
R₁₅ is selected from the group consisting of C₁-C₆-alkyl, C₃-C₈-cycloalkyl, C₃-C₈-alkenyl and aryl.

The term “C₁-C₆-alkyl” is used to denote straight or branched chain hydrocarbon radicals and these optionally substituted, unless otherwise specified, with 1-2 groups selected from the group consisting of hydroxy, halogen, carboxy, cyano, aryl, aryloxy, arylthio, C₃-C₈-cycloalkyl, C₁-C₆-alkoxy, C₁-C₆-alkylthio; C₁-C₆-alkylsulfonyl; arylsulfonyl; C₁-C₆-alkoxycarbonyl, and C₁-C₆-alkanoyloxy.

The terms “C₁-C₆-alkoxy”, “C₁-C₆-alklythio”, “C₁-C₆-alkylsulfonyl”, “C₁-C₆-alkoxycarbonyl”, “C₁-C₆-alkoxycarbonyloxy”, “C₁-C₆-alkanoyl”, and “C₁-C₆-alkanoyloxy” denote the following structures, respectively: —OC₁-C₆-alkyl, —S-C₁-C₆-alkyl, —O₂S—C₁-C₆-alkyl, —CO₂—C₁-C₆-alkyl, —OCO₂C₁-C₆-alkyl, —OC—C₁-C₆-alkyl, and —OCO—C₁-C₆-alkyl wherein the C₁-C₆-alkyl groups may optionally be substituted with up to two groups selected from hydroxy, cyano, aryl, —OC₁-C₄-alkyl, —OCOC₁-C₄-alkyl and —CO₂C₁-C₄-alkyl, wherein the C₁-C₄-alkyl portion of the groups represents a saturated straight or branched chain hydrocarbon radical that contains one to four carbon atoms.

The terms “C₃-C₈-cycloalkyl” and “C₃-C₈-alkenyl” are used to denote saturated cycloaliphatic radicals and straight or branched chain hydrocarbon radicals containing at least one carbon-carbon double bond, respectively, with each radical containing three to eight carbon atoms.

The terms “C₁-C₁₂-alkylene”, “C₂-C₆-alkylene” and “C₁-C₂-alkylene denote straight or branched chain divalent hydrocarbon radicals containing one to twelve, two to six, and one to two carbon atoms, respectively, and these optionally substituted with one or two groups selected from hydroxy, halogen, aryl and C₁-C₆-alkanoyloxy.

The term “C₃-C₈-alkenylene”is used to denote a divalent straight or branched chain hydrocarbon radical that contains at least one carbon-carbon double bond and with each radical containing three to eight carbon atoms.

In the terms “aryl”, “aryloxy”, “arylthio”, arylsulfonyl” and “aroyl” the aryl groups or aryl portions of the groups are selected from phenyl and naphthyl, and these may optionally be substituted with hydroxy, halogen, carboxy, C₁-C₆-alkyl, C₁-C₆-akoxy and C₁-C₆-alkoxycarbonyl.

In the terms “heteroaryl” and “heteroarylthio” the heteroaryl groups or heteroaryl portions of the groups are mono or bicyclo heteroaromatic radicals containing at least one hetero atom selected from the group consisting of oxygen, sulfur and nitrogen or a combination of these atoms, in combination with carbon to complete the aromatic ring. Examples of suitable heteroaryl groups include: furyl, thienyl, benzothiazoyl, thiazolyl, isothiazolyl, pryazolyl, pyrrolyl, thiadiazolyl, oxadiazolyl, benzoxazolyl, benzimidazolyl, pyridyl, pyrimidinyl and triazolyl and such groups substituted with 1-2 groups selected from C₁-C₆— alkyl, C₁-C₆-alkoxy, C₃-C₈-cycloalkyl, cyano, halogen, carboxy, C₁-C₆-alkoxycarbonyl, aryl, arylthio, aryloxy and C₁-C₆-alkylthio.

The term “halogen” is used to include fluorine, chlorine, bromine and iodine.

The term “carbamoyl” is used to represent the group having the formula: —CON(R₁₃)R₁₄, wherein R₁₃ and R₁₄ are as previously defined.

The term “arylene” is used to represent 1,2-; 1,3-: 1,4-phenylene and these radicals optionally substituted with 1-2 groups selected from C₁-C₆-alkyl, C₁-C₆-alkoxy and halogen.

The above divalent linking groups L₁ and L₂ can be selected from a variety of divalent hydrocarbon moieties including: C₁-C₁₂-alkylene, —(CHR′CHR″O—)ₚCH₂CH₂—, C₃-C₈-cycloalkylene, —CH₂—C₃-C₈-cycloalkylene —CH₂— and C₃-C₈-alkenylene. The C₁-C₁₂ alkylene linking groups may contain within their main chain heteroatoms, e.g. oxygen, sulfur and nitrogen and substituted nitrogen (—N(R₁₃)—), wherein R₁₃ is as previously defined, and/or cyclic groups such as C₃-C₈-cycloalkylene, arylene, divalent heteroaromatic groups or ester groups such as:

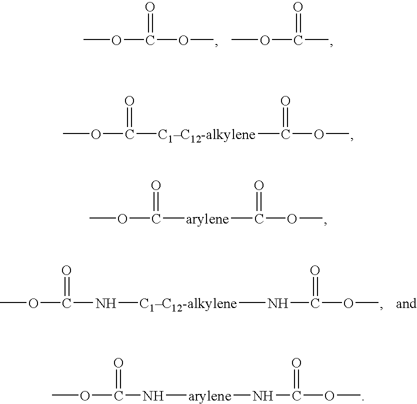

Some of the cyclic moieties which may be incorporated into the C₁-C₁₂-alkylene chain of atoms include:

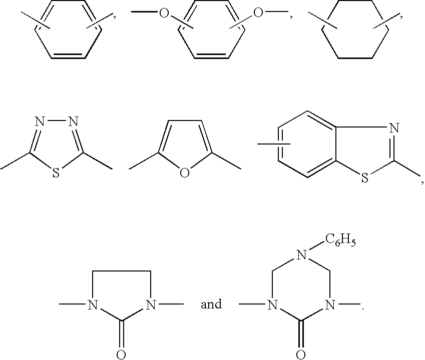

The skilled artisan will understand that each of the references herein to groups or moieties having a stated range of carbon atoms such as C₁-C₄-alkyl, C₁-C₆-alkyl, C₁-C₁₂-alkyl, C₃-C₈-cycloalkyl, C₃-C₈-alkenyl, C₁-C₁₂-alkylene, C₂-C₆-alkylene, etc. includes moieties of all of the number of carbon atoms mentioned within the ranges. For example, the term “C₁-C₆-alkyl” includes not only the C₁ group (methyl) and C₆ group (hexyl) end paints, but also each of the corresponding C₂, C₃, C₄, and C₅ groups including their isomers. In addition, it will be understood that each of the individual points within a stated range of carbon atoms may be further combined to describe subranges that are inherently within the stated overall range. For example, the term “C₃-C₈-cycloalkyl” includes not only the individual cyclic moieties C₃ through C₈, but also contemplates subranges such as C₄-C₆-cycloalkyl.

The term “polyester reactive group” is used herein to describe a group which is reactive with at least one of the functional groups from which the polyester is prepared under polyester forming conditions. Example of such groups are hydroxy, carboxy, C₁-C₆-alkoxycarbonyl, C₁-C₆-alkoxycarbonyloxy and C₁-C₆-alkanoyloxy.

One skilled in the art will understand that various thermoplastic articles can be made where excellent UV protection of the contents would be important. Examples of such articles includes bottles, storage containers, sheets, films, fibers, plaques, hoses, tubes, syringes, and the like. Basically, the possible uses for polyester having a low-color, low-migratory UV absorber is voluminous and cannot easily be enveloped.

The present invention is illustrated in greater detail by the specific examples presented below. It is to be understood that these examples are illustrative embodiments and are not intended to be limiting of the invention, but rather are to be construed broadly within the scope and content of the appended claims.

Preparation of a furyl-2-methylidene UV absorbing compounds are illustrated by the following examples.

### EXAMPLE 1

The following materials, in the amounts shown, were added to a clean 2 litter flask equipped with a mechanical stirrer, thermocouple, and a reflux condenser:

| | |
|---|---|
| cyanoacetic acid | 200 grams, (2.35 moles) |
| pentaerythritol | 53.39 grams, (0.392 moles) |
| toluene | 500 milliliters |
| p-toluenesulfonic acid monohydrate | 2.67 grams |

The reaction mixture was heated with stirring to 105° C. until water distillation stopped, at which time approximately 28 mL of water were collected. The reaction mixture was allowed to cool to room temperature and the toluene layer was decanted. One liter of ethyl acetate was added to the remaining oil and the mixture was stirred until a solution was obtained. Water (500 mL) was added to the stirring reaction mixture followed by sodium bicarbonate (50 g, 0.6 mols) in several small quantities to neutralize any remaining acids. The mixture was transferred into a separatory funnel where the water layer was removed and discarded. Neutralization with aqueous sodium bicarbonate was repeated until the aqueous washes were basic. The ethyl acetate layer was washed twice with 200 mL of water and twice with 200 mL of brine solution. The resulting oil was dried over anhydrous MgSO₄, filtered and concentrated to give about 100 g of a light yellow oil. The resulting oil (10.0 g, 24.75 mmols), 2-furaldehyde (9.75 g, 101.5 mmols), piperidine acetate (147 mg, 1.01 mmols) and 150 mL of anhydrous ethanol were added to a 250 mL round bottomed flask equipped with a magnetic stir bar. The reaction mixture was stirred at ambient temperature for about 50 hours. The product, identified as the UV absorbing compound of Formula VI above, was precipitated by the slow addition of 750 mL of deionized water with stirring. The solid was collected by suction filtration and washed with 200 mL of deionized water followed by 50 mL of methanol and allowed to dry on the filter overnight to give about 12 g of a pale yellow solid. The UV absorbing compound exhibited a wavelength of maximum absorbance (λₘₐₓ) at 342 nm. The molar extinction coefficient (ε) was determined to be 90,596.

### COMPARATIVE EXAMPLE 1

Polyester oligomer was prepared by adding the UV absorbing compound to the esterification reactor at the initiation of the esterification reaction. To prepare the polyester oligomer the following reactants were mixed together in a stainless steel beaker: 651.35 g of purified terephthalic acid (3.92 moles); 13.29 g of purified isophthalic acid (0.08 moles); 397.25 g of virgin ethylene glycol (6.40 moles); 0.23 g of antimony trioxide, and 0.309 g of UV absorbing compound which theoretically will provide a concentration of 400 parts of absorbing compound to 1,000,000 parts of polymer. The UV absorbing compound had the following the formula:

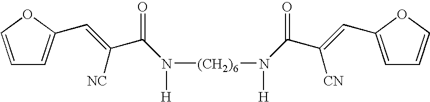

The reactants were mixed using a 2-inch radius paddle stirrer connected to an electric motor to form a paste. After approximately ten minutes of stirring, the paste was aspirated into a stainless steel, 2-liter volume, pressure reactor. After the entire mixture had been charged to the reactor, the reactor was purged three times by pressurizing with nitrogen then venting the nitrogen. During the initial pressurization, stirring was initiated using a 2-inch diameter anchor-style stirring element driven by a magnetic coupling to a motor. Stirring was increased until a final rate of 180 rpm, as measured by the shaft's rotation, was achieved.

After the pressure inside the reactor reached 40 pounds per square inch (psi), the pressure was slowly vented to return the system to near atmospheric pressure while maintaining a slow nitrogen bleed through the reactor. After the final nitrogen purge the pressure within the reactor was again increased to 40 psi.

Following this final pressurization step, the reactor's contents were heated to 245° C. over approximately 60 minutes using a resistance heating coil external to the reactor's contents. During the heat-up time, the reactor's pressure and stirring rate were maintained at 40 psi and 180 rpm, respectively.

After the target reaction temperature of 245° C. was achieved the reaction conditions were kept constant for the duration of the reaction sequence. The reaction time was 200 minutes based upon an expected extent of completion of the esterification reactions. The by-product of the reaction is water. The actual extent of reaction was estimated by monitoring the mass of water collected over time. Water was removed from the vessel by distilling the water vapor from the reactor through a one inch diameter, 2.5 foot long, heated vertical column, fitted to the reactor's head. This column was packed with ¼″ diameter glass beads to facilitate the separation of the low boiling reaction by-products from free ethylene glycol and the esterification products. The column was connected by a horizontal section of pipe to a water cooled condenser. The lower end of the condenser was fitted with a pressure control valve that was positioned directly above a beaker resting on a balance. This arrangement allowed for the continuous removal of low-by-products boiling reaction by-products from the reactor.

At the end of 200 minutes, the reactor pressure was reduced to atmospheric pressure over a twenty-five minute time period. The oligomer was collected in a stainless steel pan, allowed to cool and then analyzed.

Analyses of the oligomer product using proton nuclear magnetic resonance spectroscopy (NMR) determined the extent of reaction, the molar ratio of ethylene glycol to terephthalate and isophthalate moieties, the diethylene glycol content and the end group concentration.

The oligomer was allowed to harden, pulverized and subsequently polymerized as described below.

Approximately 119 μg of granulated oligomer product were placed into a 500 ml round-bottom flask. A stainless steel paddle stirrer with a ¼ inch (0.635 cm) diameter shaft and a 2 inch (5.08 cm) diameter paddle was inserted into the round-bottom flask. An adapter fabricated with fittings for a nitrogen purge line, a vacuum line/condensate takeoff arm, a vacuum tight stirring shaft adapter, and a rubber septum for injection of additives, was inserted into the flask's 24/40 standard taper ground glass joint.

A nitrogen purge was initiated and the assembled apparatus was immersed into a pre-heated, molten metal bath whose temperature had equilibrated at 225° C. Once the flask's contents had melted, stirring was initiated. The conditions used for the entire reaction process are summarized in table below.

TABLE I

| | Duration | Temp. | Pressure | Stirring Rate |
|---|---|---|---|---|
| Stage | (minutes) | (° C.) | (mm Hg) | (rpm of shaft) |
| 1 | 0.1 | 225 | Atmospheric | 25 |
| 2 | 5 | 225 | Atmospheric | 25 |
| 3 | 20 | 265 | Atmospheric | 50 |
| 4 | 5 | 265 | Atmospheric | 100 |
| 5 | 5 | 285 | Atmospheric | 100 |
| 6 | 1 | 285 | 200 | 100 |
| 7 | 1 | 285 | 0.8 | 100 |
| 8 | 75 | 285 | 0.8 | 75 |
| 9 | 1 | 285 | 150 | 0 |

Phosphorus was injected into the mixture at stage 6 as a solution of phosphoric acid in ethylene glycol. The target level of phosphorus was 20 ppm based on the theoretical yield of polyester. After completion of the reaction time indicated in Table I above, the metal bath was removed and the stirring stopped. Within fifteen minutes the polymer mass had cooled sufficiently to solidify. The cooled solid was isolated from the flask and ground in a Wiley hammer mill to produce a coarse powder whose average particle diameter was less than 3 mm. The powder was submitted for various tests such as solution viscosity, color, diethylene glycol content and ultraviolet absorber concentration.

The described reaction procedure typically produces a polyester having an intrinsic viscosity as measured at 25° C. in a mixture of 60% by weight phenol, 40% by weight 1,1,2,2-tetrachloroethanol, within the range of 0.60-0.72 dL/g.

The yield of UV absorbing compound present in the polymer was 4%. This was determined by measuring the absorbance of a solution produced by dissolving a known mass (˜0.2 g) of the reaction product in 25 ml of a trifluoroacetic acid (TFA)-methylene chloride (5% by weight TFA, 95% methylene chloride) mixture. The absorbance of the solution was compared to that of a standard series produced by spiking mixtures of 5% trifluoroacetic acid—95% methylene chloride with known quantities of the UV absorbing compound. Absorbance measurements for this series of samples produced a relationship between the concentration of UV absorber compound and a solution's absorbance in accordance with Beer's law: A=abc (where A=absorbance, a=molar absorptivity, b=path length and c=concentration). Measurements were made using a 1 cm cell with a Perkin-Elmer Lambda 35 spectrophotometer. Absorbance was measured for all samples at 345 nm. Neat solvent mixture was used to blank the instrument prior to the evaluation of the ultraviolet absorber containing samples. The concentration of the UV absorber compound was determined by extrapolation of the test sample's absorbance to the linear fit of the absorbance vs. concentration data generated for the standard series.

### EXAMPLE 1

Polyester oligomer was prepared in accordance with Comparative Example 1 above, except that no ultraviolet absorber was added to the mixture charged to the pressure reactor. Instead, 2.0 grams of a mixture containing 2.00 g of UV absorber compound of Comparative Example 1 in 100 g of ethylene glycol was added to the flask at the initiation of polymerization. This addition level theoretically will provide a concentration of 400 parts of absorbing compound to 1,000,000 parts of polymer.

The yield of UV absorber compound present in the polymer product was 49%.

### EXAMPLE 2

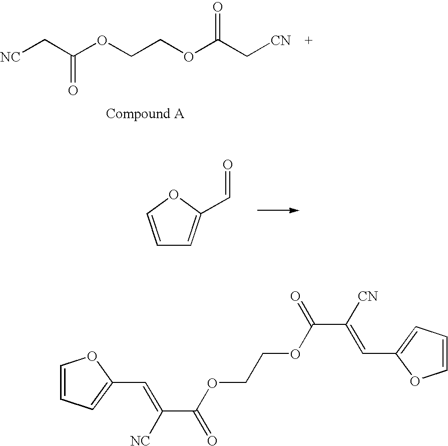

Compound A was first prepared in accordance with U.S. Pat. No. 5,532,332. To a 250 mL round bottom flask equipped with a magnetic stirrer and heating mantle were added the following reactants and in the amounts specified below:

| Reactant | Amount |
|---|---|
| Compound A | 8.13 grams |
| 2-furaldehyde* | 8.49 grams |
| anhydrous ethanol | 70 mL |
| piperidine acetate | 1.28 grams |

*Available from Aldrich Chemical

The reaction mixture was then heated to 60° C. for about one hour while stirring. The reaction mixture was allowed to cool to room temperature and crystals formed upon cooling. Water was added to further precipitate the product. The precipitate was collected by suction filtration and washed with 100 mL of water followed by 20 mL of cold methanol. The cake was allowed to dry on the filter overnight to give about 10 g of an off white solid. The product identity was confirmed using flame desorption mass spectrometry (FD-MS).

### EXAMPLE 3

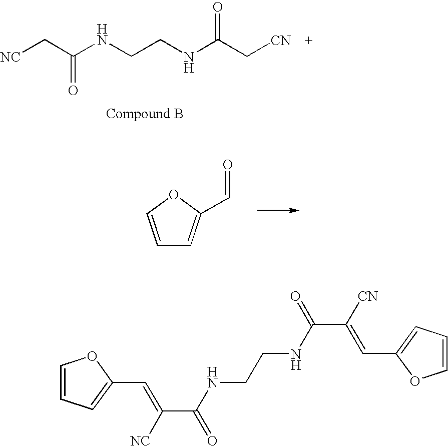

Compound B was first prepared in accordance with U.S. Pat. No. 5,532,332. To a 250 mL round bottom flask equipped with a magnetic stirrer and heating mantle were added the following reactants and in the amounts specified below:

| Reactant | Amount |
|---|---|
| Compound B | 6.0 grams |
| 2-furaldehyde | 5.94 grams |
| anhydrous ethanol | 50 mL |
| sodium methoxide in methanol | 0.5 mL of 25 wt. % |

The reaction mixture was stirred at room temperature until complete according to TLC analysis (less than 1 hour). The product was precipitated by adding 250 mL of water. The precipitate was collected by suction filtration and washed with 200 mL of water followed by 20 mL of cold methanol. The cake was allowed to dry on the filter overnight to give 8.52 g of an off white solid. The product identity was confirmed using flame desorption mass spectrometry (FD-MS).

### EXAMPLE 4

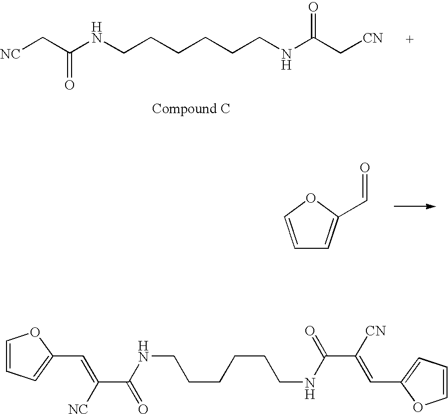

Compound C was first prepared in accordance with U.S. Pat. No. 5,532,332. To a 250 mL round bottom flask equipped with a magnetic stirrer and heating mantle were added the following reactants and in the amounts specified below:

| Reactant | Amount |
|---|---|
| Compound C | 10.0 grams |
| 2-furaldehyde | 7.69 grams |
| anhydrous ethanol | 100 mL |
| sodium methoxide in methanol | 0.5 mL of 25 wt. % |

The reaction mixture was stirred at room temperature until complete according to TLC analysis (less than 1 hour). The product was precipitated by adding 750 mL of water. The precipitate was collected by suction filtration and washed with 200 mL of water followed by 20 mL of cold methanol. The cake was allowed to dry on the filter overnight to give 12.71 g of an off white solid. The product identity was confirmed using flame desorption mass spectrometry (FD-MS).

Having described the invention in detail, those skilled in the art will appreciate that modifications may be made to the various aspects of the invention without departing from the scope and spirit of the invention disclosed and described herein. It is, therefore, not intended that the scope of the invention be limited to the specific embodiments illustrated and described but rather it is intended that the scope of the present invention be determined by the appended claims and their equivalents. Moreover, all patents, patent applications, publications, and literature references presented herein are incorporated by reference in their entirety for any disclosure pertinent to the practice of this invention.

1. A method for incorporating greater than 40% of a UV light absorbing compound into a polyester prepared using direct esterification of reactants comprising a dicarboxylic acid and a diol, said method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 50% of the carboxy groups initially present in the reactants have been esterified, wherein said UV absorbing compound comprises at least one furyl-2-methylidene radical of Formula I: 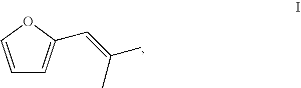
wherein the UV absorbing compound includes a polyester reactive group.

2. The method of claim 1 wherein said dicarboxylic acid is selected from the group consisting of aliphatic, alicyclic, or aromatic dicarboxylic acids.

3. The method of claim 2 wherein said dicarboxylic acid is selected from the group consisting of terephthalic acid; naphthalene dicarboxylic acid; isophthalic acid; 1,4-cyclohexanedicarboxylic acid; 1,3-cyclohexanedicarboxylic acid; succinic acid; glutaric acid; adipic acid; sebacic acid; and 1,12-dodecanedioic acid.

4. The method of claim 1 wherein said diol is selected from the group consisting of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane wherein X represents 3, 4, or 5; diethylene glycol, triethylene glycol, dipropylene glycol, tripropylene glycol; diols containing from about 2 to about 18 carbon atoms in each aliphatic moiety and mixtures thereof.

5. The method of claim 1 wherein said polyester comprises greater than 50 mole % terephthalic acid residues and greater than 50 mole % ethylene glycol residues, wherein the acid component has 100 mole % and the diol component has 100 mole %.

6. The method of claim 1 wherein said polyester comprises greater than 75 mole % terephthalic acid residues and greater than 75 mole % ethylene glycol residues, wherein the acid component has 100 mole % and the diol component has 100 mole %.

7. The method of claim 1 wherein said light absorbing compound is added to at least one of said reactors when at least about 70% of the carboxy groups initially present in the reactants have been esterified.

8. The method of claim 1 wherein said UV absorbing compound is added to at least one of said reactors when at least about 80% of the carboxy groups initially present in the reactants have been esterified.

9. The method of claim 1 wherein said UV absorbing compound is added to at least one of said reactors when at least about 85% of the carboxy groups initially present in the reactants have been esterified.

10. The method of claim 1 wherein said UV absorbing compound is added to at least one of said reactors when greater than about 90% of the carboxy groups initially present in the reactants have been esterified.

11. The method of any one of claims 1 and 7-10 wherein from 0-100% of said UV absorbing compound is added to the esterification reactor.

12. The method of claim 11 wherein less than 80% of said UV absorbing compound is added to the esterification reactor.

13. The method of claim 11 wherein less than 50% of said UV absorbing compound is added to the esterification reactor.

14. The method of any one of claims 1 and 7-10 wherein from 0-100% of said UV absorbing compound is added to the polycondensation reactor.

15. The method of claim 14 wherein greater than 50% of said UV absorbing compound is added to the polycondensation reactor.

16. The method of claim 14 wherein greater than 80% of said UV absorbing compound is added to the polycondensation reactor.

17. The method of claim 14 wherein greater than 95% of said UV absorbing compound is added to the polycondensation reactor.

18. The method of claim 1 wherein said UV absorbing compound is selected from the group consisting of compounds represented by Formulae II and III: 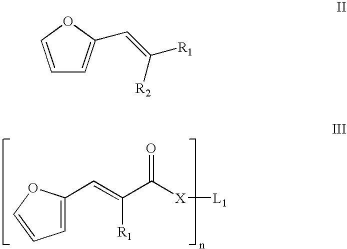
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′CHR″O—)ₚCH₂CH₂R₄, C₃-C₈-alkenyl, C₃-C₈-cycloalkyl, aryl, and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbon having three or four covalent bonds.

19. The method of claim 18 wherein said UV absorbing compound is selected from the group consisting of compounds represented by the Formulae IV-VI: 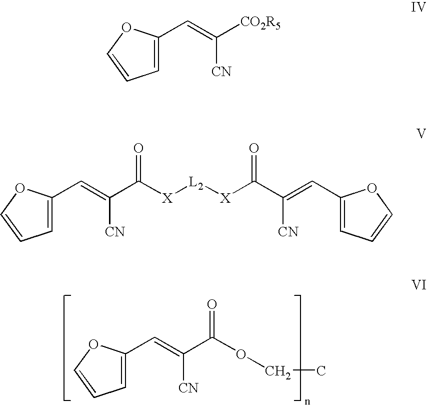
wherein:
R₅ is selected from the group consisting of C₁-C₆-alkyl, cyclohexyl, phenyl, and —(CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

20. The method of claim 1 wherein the amount of UV absorbing compound incorporated into said polyester has a yield greater than 50%.

21. The method of claim 20 wherein the yield is greater than 60%.

22. The method of claim 20 wherein the yield is greater than 70%.

23. The method of claim 20 wherein the yield is greater than 85%.

24. A method for incorporating of a UV light absorbing compound into a polyester prepared using direct esterification of reactants which include a dicarboxylic acid and a diol, said method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 70% of the carboxy groups initially present in the reactants have been esterified, wherein said UV absorbing compound comprises at least one furyl-2-methylidene radical of Formula I: 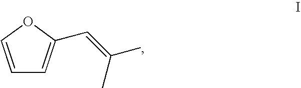
wherein the UV absorbing compound includes a polyester reactive group.

25. The method of claim 24 wherein said dicarboxylic acid is selected from the group consisting of terephthalic acid; naphthalene dicarboxylic acid; isophthalic acid; 1,4-cyclohexanedicarboxylic acid; 1,3-cyclohexanedicarboxylic acid; succinic acid; glutaric acid; adipic acid; sebacic acid; and 1,12-dodecanedioic acid and wherein said diol is selected from the group consisting of ethylene glycol; 1,4-cyclohexanedimethanol; 1,2-propanediol; 1,3-propanediol; 1,4-butanediol; 2,2-dimethyl-1,3-propanediol; 1,6-hexanediol; 1,2-cyclohexanediol; 1,4-cyclohexanediol; 1,2-cyclohexanedimethanol; 1,3-cyclohexanedimethanol; 2,2,4,4-tetramethyl-1,3-cyclobutane diol; X,8-bis(hydroxymethyl)tricyclo-[5.2.1.0]-decane wherein X represents 3, 4, or 5; diethylene glycol, triethylene glycol, dipropylene glycol, tripropylene glycol; diols containing from about 2 to about 18 carbon atoms in each aliphatic moiety and mixtures thereof.

26. The method of claim 24 wherein said polyester comprises greater than 75 mole % terephthalic acid residues and greater than 75 mole % ethylene glycol residues, wherein the acid component has 100 mole % and the diol component has 100 mole %.

27. The method of claim 24 wherein said UV absorbing compound is added to at least one of said reactors when at least about 80% of the carboxy groups initially present in the reactants have been esterified.

28. The method of claim 24 wherein said UV absorbing compound is added to at least one of said reactors when greater than about 90% of the carboxy groups initially present in the reactants have been esterified.

29. The method of claim 24, 27 or 28 wherein from 0-100% of said UV absorbing compound is added to the esterification reactor.

30. The method of claim 24, 27 or 28 wherein from 0-100% of said UV absorbing compound is added to the polycondensation reactor.

31. The method of claim 24 wherein the amount of UV absorbing compound incorporated into said polyester has a yield greater than 50%.

32. The method of claim 24 wherein the yield is greater than 70%.

33. The method of claim 24 wherein the yield is greater than 85%.

34. The method of claim 24 wherein said UV absorbing compound is selected from the group consisting of compounds represented by Formulae II and III: 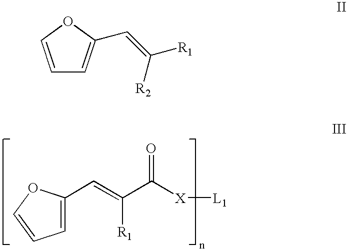
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbon having three or four covalent bonds.

35. The method of claim 34 wherein said UV absorbing compound is selected from the group consisting of compounds represented by the Formulae IV-VI: 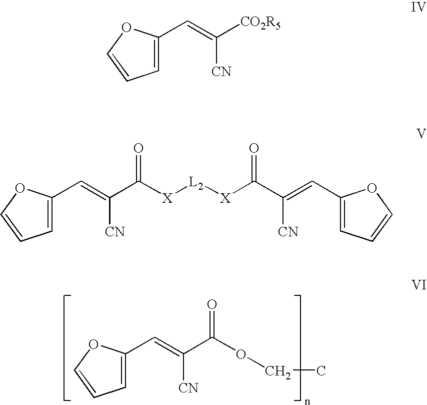
wherein:
R₅ is selected from the group consisting of C₁-C₆-alkyl, cyclohexyl, phenyl, and (CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

36. The method of claim 18, 19, 34, or 35 wherein said alkoxylated moiety represented by the formula —(CHR′CHR″O—)ₚ is selected from the group consisting of ethylene oxide residues, propylene oxide residues, or residues of both, and p is less than about 50.

37. The method of claim 36 wherein p is less than 8.

38. The method of claim 36 wherein p is from 1-3.

39. A polyester prepared using direct esterification of reactants comprising a dicarboxylic acid and a diol, wherein greater than 40% of a UV light absorbing compound is incorporated into the polyester by the method comprising:
a. combining said reactants in an esterifying reactor under conditions sufficient to form an esterified product comprising at least one of: an ester, an oligomer, a low molecular weight polyester and mixtures thereof;
b. polymerizing the esterified product in a polycondensation reactor to form a polyester; and
c. adding at least one UV absorbing compound to at least one of said esterification reactor or polycondensation reactor when at least 50% of the carboxy groups initially present in the reactants have been esterified, wherein said UV absorbing compound comprises at least one furyl-2-methylidene radical of Formula I: 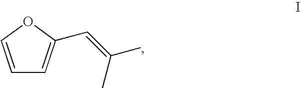
wherein the UV absorbing compound includes a polyester reactive group.

40. The polyester of claim 39 wherein said UV absorbing compound is selected from the group consisting of compounds represented by Formulae II and III: 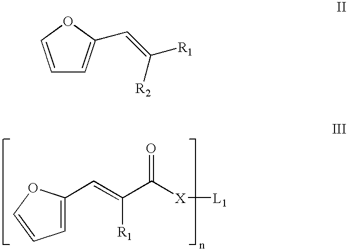
wherein:
X is selected from the group consisting of oxygen, —NH—, and —N(R′)—;
n is a whole number ranging from 2 to 4;
R₁ is selected from the group consisting of —CO₂R₃ and cyano;
R₂ is selected from the group consisting of cyano, —CO₂R₃, C₁-C₆-alkylsulfonyl, arylsulfonyl, carbamoyl, C₁-C₆-alkanoyl, aroyl, aryl, and heteroaryl;
R₃ is selected from the group consisting of hydrogen, C₁-C₁₂-alkyl, substituted C₁-C₁₂-alkyl, —(CHR′—CHR″O—)ₚCH₂CH₂R₄, C₃-C₈-alkenyl, C₃-C₈-cycloalkyl, aryl and cyano, wherein p is an integer of from 1 to 100;
R₄ is selected from the group consisting of hydrogen, hydroxy, C₁-C₆-alkoxy, C₁-C₆-alkanoyloxy and aryloxy;
R′ and R″ are independently selected from hydrogen and C₁-C₁₂-alkyl;
L₁ is a di, tri, or tetravalent linking group, where the divalent radical is selected from the group consisting of C₂-C₁₂-alkylene, —(CHR′CHR″O—)ₚCHR′CHR″—, C₁-C₂-alkylene-arylene-C₁-C₂-alkylene, —CH₂CH₂O-arylene-OCH₂CH₂—, and —CH₂-1,4-cyclohexylene-CH₂—; wherein p is an integer from 1 to 100, and wherein the trivalent and tetravalent radicals are selected from the group consisting of C₃-C₈ aliphatic hydrocarbon having three or four covalent bonds.

41. The polyester of claim 40 wherein said UV absorbing compound is selected from the group consisting of compounds represented by the Formulae IV-VI: 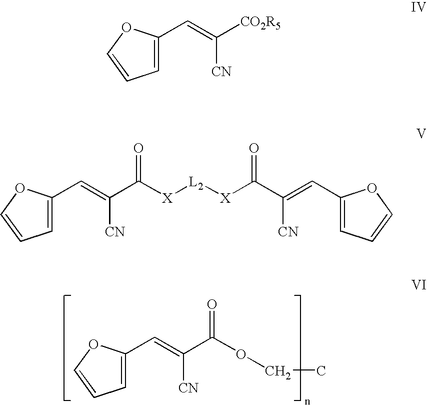
wherein:
R₅ is selected from the group consisting of C₁-C₆-alkyl, cyclohexyl, phenyl, and —(CHR′CHR″O—)ₚR₆, wherein p is an integer from 1 to 100;
R₆ is selected from hydrogen, C₁-C₆-alkoxy, and C₁-C₆-alkanoyloxy; and
L₂ is selected from the group consisting of C₂-C₆-alkylene, —(CHR′CHR″O—)ₚCHR′CHR″—, and —CH₂-cyclohexane-1,4-diyl-CH₂—, wherein p is an integer from 1 to 100.

42. The polyester of claim 40 or 41 wherein said alkoxylated moiety represented by the formula —(CHR′CHR″O—)ₚ is selected from the group consisting of ethylene oxide residues, propylene oxide residues, or residues of both, and p is less than about 50.

43. The polyester of claim 42 wherein p is less than 8.

44. The polyester of claim 42 wherein p is from 1-3.

45. A thermoplastic article prepared using the polyester of claim 39.

46. A thermoplastic article prepared from the polyester of claim 40.

47. A thermoplastic article prepared from the polyester of claim 41.

48. The thermoplastic article of claim 45, 46 or 47 wherein said article is selected from the group consisting of bottles, storage containers, sheets, films, plaques, hoses, tubes, and syringes.

49. The thermoplastic article of claim 46 or 47 wherein said alkoxylated moiety represented by the formula —(CHR′CHR″O—)ₚ is selected from the group consisting of ethylene oxide residues, propylene oxide residues, or residues of both, and p is less than about 50.

50. The thermoplastic article of claim 49 wherein p is less than 8.

51. The thermoplastic article of claim 49 wherein p is from 1-3.
